(19) United States
(12) Patent Application Publication
(10) Pub. No.: US 2020/0008377 A1
(43) Pub. Date: Jan. 9, 2020

(54) Aquatic Plant Growing Equipment

(71) Applicant: Hirose Co., Ltd., Funabashi-city (JP)

(72) Inventor: Mitsuru Hirose, Funabashi-city (JP)

(21) Appl. No.: 16/223,544

(22) Filed: Dec. 18, 2018

(30) Foreign Application Priority Data
Jul. 9, 2018 (JP) 2018-129795

(51) Int. Cl. A01G 31/06; A01G 33/00; A01K 63/04; A23K 50/80

(52) U.S. Cl. CPC A01G 31/06; A01G 33/00; A01D 44/00; A23K 50/80; A01K 63/04

(57) ABSTRACT

An aquatic plant growing equipment includes a plant growing container which includes a bottom portion graveling sintered soil particles allowing permeation of water and having porous as bed soil and a side portion surrounding the bottom portion, is disposed at an uppermost side, a water purifying container which includes a bottom portion graveling sintered soil particles having porous as bed soil and a side portion surrounding the bottom portion, and with which, at the side portion, a water drain pipe communicating with a pump penetrates through and a water suction hole is installed or a water suction pipe communicating with the pump penetrates through and a water drain hole is installed, is disposed at a lowermost side, and the plant growing container and the water purifying container are coupled directly or are coupled indirectly through another water purifying container and/or plant growing container.

### TECHNICAL FIELD

The present invention relates to an aquatic plant growing equipment, with which sintered soil particles that are porous and contribute to growth of aquatic plants and water purification are graveled and which is to be installed in an aquarium tank.

### BACKGROUND ART

As indicated in Patent Document 1, it is already adopted as a prior art to lay sintered soil particles as bed soil on a bottom portion of a container and install the container inside an aquarium tank to grow aquatic plants and purify water by the sintered soil particles.

Moreover, it is also already adopted in Patent Document 2 to form volcanic-ash-deposit-based soil into a porous granular state and thereupon contribute to growing aquatic plants and purifying water.

However, in cases where, as in the prior art, sintered soil particles are layered as a single layer of bed soil and used for both growing aquatic plants and purifying water, technical problems, such as the following, cannot be avoided.

Firstly, a water circulation velocity appropriate for growing the aquatic plants differs from a water circulation velocity appropriate for purifying water and despite this, with the prior art, a water circulation velocity in the single layer of bed soil is uniform and therefore mutually different water circulation velocities cannot be adopted.

Consequently, when a water circulation velocity such that is adapted to purification is adopted, a downward circulation of water that is excessive for roots of the aquatic plants is generated and this inevitably hinders the growth of the aquatic plants.

On the other hand, when water that is appropriate for growing the aquatic plants is circulated downward, this is insufficient in regard to purifying water and water inside the aquarium tank cannot be kept in a clear state over a long period.

Secondly, with the prior art, fish feces and other foul matter pile on a surface of the bed soil to obstruct water circulation at the roots of the aquatic plants, thus causing a need to frequently remove the accumulated foul matter.

Thirdly, there are cases where dust and dirt circulating in water enters between the sintered soil particles constituting the bed soil to cause clogging of the sintered soil particles.

Although if the clogging occurs gradually, the sintered soil particles may be replaced after using for approximately five years, if the clogging occurs frequently, it is deemed necessary to replace the sintered soil particles in approximately three months.

In either case, a troublesome replacement process of detaching the sintered soil particles bound to the aquatic plants is deemed indispensable.

Fourthly, although when the roots of the aquatic plants enter into interiors of the sintered soil particles, the sintered soil particles become destroyed and a purifying function decreases in accordance with the destruction, the decrease cannot be dealt with when the sintered soil particles are used to purify water as well.

### PRIOR ART DOCUMENTS

### Patent Documents

[Patent Document 1] Japanese Patent No. 2603202

[Patent Document 2] Japanese Patent No. 2917140

### SUMMARY OF INVENTION

### Technical Problem

An object of the present invention is to provide a configuration of an aquatic plant growing equipment, with which, in regard to sintered soil particles that are porous, a function for growing plants and a water purifying function are achieved by adoption of different bed soils.

### Solution to Problem

To achieve the above object, a basic configuration of the present invention is constituted of:

(1) an aquatic plant growing equipment to be installed inside an aquarium tank, comprising a plant growing container which includes a bottom portion graveling sintered soil particles allowing permeation of water and having porous as bed soil and a side portion surrounding the bottom portion, is disposed at an uppermost side, a water purifying container which includes a bottom portion graveling sintered soil particles having porous as bed soil and a side portion surrounding the bottom portion, and with which, at the side portion, a water drain pipe communicating with a pump penetrates through and a water suction hole is installed, is disposed at a lowermost side, and the plant growing container disposed at the uppermost side and the water purifying container disposed at the lowermost side are coupled directly or are coupled indirectly in a vertical direction through one or a plurality of the water purifying containers and/or the plant growing containers in order, or

(2) an aquatic plant growing equipment to be installed inside an aquarium tank, comprising a plant growing container which includes a bottom portion graveling sintered soil particles allowing permeation of water and having porous as bed soil and a side portion surrounding the bottom portion, is disposed at an uppermost side, a water purifying container which includes a bottom portion graveling sintered soil particles having porous as bed soil and a side portion surrounding the bottom portion, and with which, at the side portion, a water suction pipe communicating with a pump penetrates through and a water drain hole is installed, is disposed at a lowermost side, and the plant growing container disposed at the uppermost side and the water purifying container disposed at the lowermost side are coupled directly or are coupled indirectly in a vertical direction through one or a plurality of the water purifying containers and/or the plant growing containers in order.

Although the basic configuration (1) and the basic configuration (2) are different with each other in whether the communication with the pump is at a water draining side or a water suction side, and are equivalent in technical value.

A configuration where the pump is communicating with both the draining side and the suction side may also be adopted and such a configuration corresponds to an utilization configuration of the basic configuration (1) and the basic configuration (2).

### Effects of the Invention

With the present invention based on the basic configurations described above, in regard to the water circulation in the plant growing container, water permeation at the bottom portion can be made gradual and meanwhile, in regard to the water circulation in the water purifying container, a circulation velocity such that is adapted to water purification can be set through circulation by the water drain pipe communicating with the pump and the water suction hole (in the case of the basic configuration (1)), or circulation by the water suction pipe communicating with the pump and the water drain hole (in the case of the basic configuration (2)).

Simply explaining, a velocity of water adapted to the growth of the aquatic plants and a velocity of water adapted to purification can be set independently.

Consequently, fish feces and other foul matter, dust, and dirt become accumulated on the bed soil of the water purifying container and do not become accumulated on the bed soil of the plant growing container, and therefore frequent cleaning of a surface of the bed soil for growing the aquatic plants is made unnecessary.

Further, although in regard to the sintered soil particles in the water purifying container, replacement is necessary as in the prior art, but the replacement can be processed by a simple replacement process because the particles do not form the bed soil for growing plants, and then a troublesome replacement process, which is due to consideration for achieving a state that would not hinder the aquatic plants that are growing as in the prior art, is made unnecessary.

### BRIEF DESCRIPTION OF DRAWINGS

FIG. 1 shows basic configurations according to embodiments, each characterized in being a two-stage configuration where a container at an uppermost side and a container at a lowermost side are coupled directly, (a) shows plan views respectively of both a region of a bottom portion of a plant growing container in which bed soil is formed by sintered soil particles, and a region of the bottom portion in which the sintered soil particles are not graveled and the bed soil is not formed, (b) shows plan views respectively of a state of a bottom portion of a water purifying container, and (c) shows side views respectively of a state where the plant growing container at the uppermost side and the water purifying container at the lowermost side are coupled directly.

FIG. 2 shows side views of embodiments, each with a water purifying container or containers interposed between the plant growing container at the uppermost side and the water purifying container at the lowermost side, (a) shows a state where one water purifying container is interposed, and (b) shows a state where a plurality (two) of the water purifying containers are interposed.

FIG. 3 shows side views of embodiments, each with a plant growing container or containers interposed between the plant growing container at the uppermost side and the water purifying container at the lowermost side, (a) shows a state where one plant growing container is interposed, and (b) shows a state where a plurality (two) of the plant growing containers are interposed.

FIG. 4 shows side views of embodiments, each with a plant growing container or containers and a water purifying container interposed between the plant growing container at the uppermost side and the water purifying container at the lowermost side, (a) shows a state where a plant growing container is interposed at an upper side of an intermediate position other than the uppermost side and the lowermost side and the water purifying container is interposed at a lower side of the intermediate position, and (b) shows a state where the water purifying container is interposed at the upper side of the intermediate position other than the uppermost side and the lowermost side, a plant growing container is interposed at the lower side of the intermediate position, and a plant growing container is interposed further below.

### DESCRIPTION OF EMBODIMENTS

Embodiments of the basic configuration (1) and the basic configuration (2) shall now be described individually in accordance with the respective drawings.

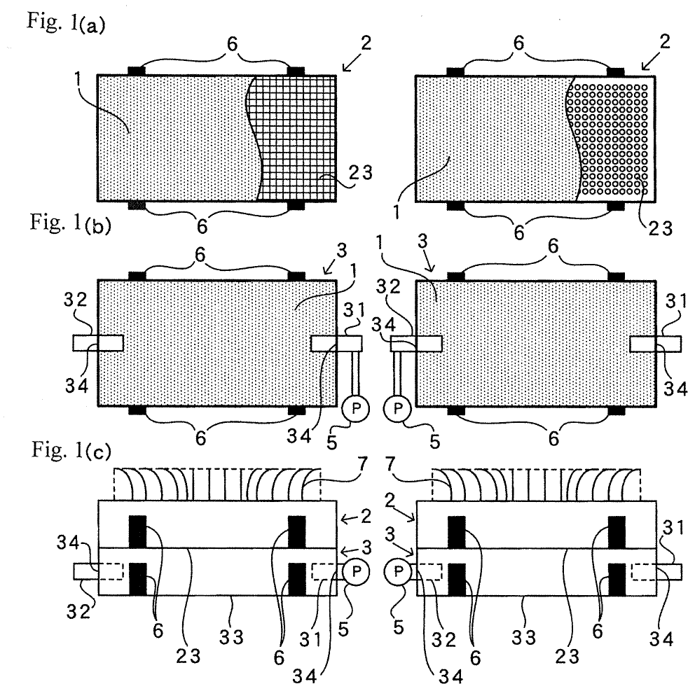

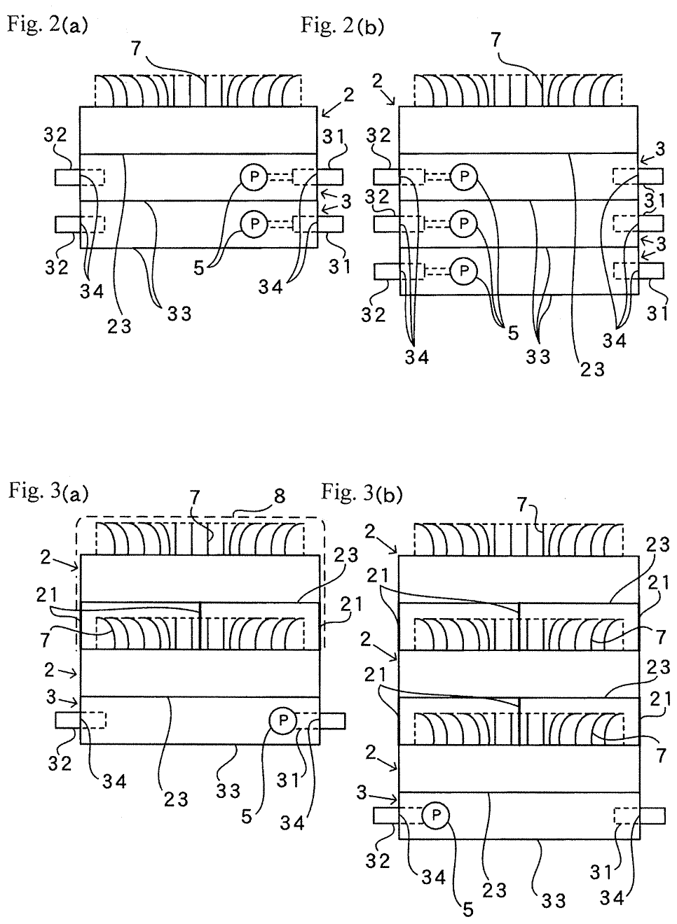

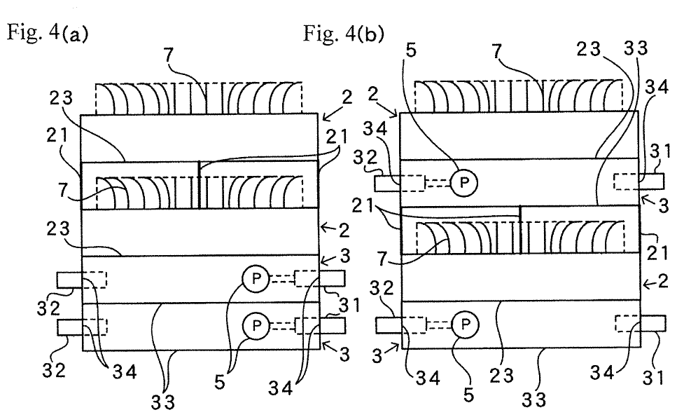

While cases based on the basic configuration (1) are shown at the left side of FIG. 1(c) and in FIG. 2(a), FIG. 3(a), and FIG. 4(a), and cases based on the basic configuration (2) are shown at the right side of FIG. 1(c) and in FIG. 2(b), FIG. 3(b), and FIG. 4(b), states based on configurations that are inverses of the above cases are also possible and either of the basic configuration (1) and the basic configuration (2) may be adopted in each of the embodiments.

FIG. 1 shows embodiments, each characterized in being a two-stage configuration where a plant growing container 2 at an uppermost side and a water purifying container 3 at a lowermost side are coupled directly in a vertical direction, FIG. 1(a) shows states respectively of a region of a bottom portion 23 of the plant growing container 2 at the uppermost side in which sintered soil particles are graveled to form bed soil 1 and a region of the bottom portion 23 in which the sintered soil particles are not graveled and the bed soil 1 is not formed, FIG. 1(b) shows states respectively of a bottom portion 33 of the water purifying container 3, and FIG. 1(c) shows states respectively of an embodiment according to the two-stage configuration.

The embodiments shown in FIG. 1 are the simplest configurations of the basic configurations and moreover enable all effects of the present invention to be achieved.

In FIG. 1(a), an embodiment adopting a mesh 8 having a diameter smaller than a diameter of the sintered soil particles as the bottom portion 23 of the plant growing container 2 is shown at the left side, and an embodiment in which a plurality of holes having a diameter smaller than the diameter of the sintered soil particles arrayed in a regular manner is shown at the right side.

Such a regular array as the above is based on consideration of aesthetics and is not meant to exclude an irregular array.

In FIG. 1(b), the basic configuration (1) adopting a water drain pipe 31 communicating with a pump is shown at the right side, and the basic configuration (2) adopting a water suction pipe 32 communicating with the pump is shown at the right side.

By thus achieving draining and suctioning of water based on actions of the pump, water circulation which is more appropriate than that undergone by the plant growing container 2 can be achieved by the water purifying container 3 and a water purifying function can be exhibited sufficiently irrespective of a water circulation appropriate for roots of aquatic plants.

With the water purifying container 3, there is no need to drain water at the bottom portion 33.

Although water is thus not required to permeate through the bottom portion 33 of the water purifying container 3, a bottom portion, such as that shown in FIG. 1(a) through which water can permeate, may obviously be adopted for convenience of manufacture.

Although in FIG. 1, a shape having a rectangular side portion and the planar bottom portion 23 or 33 is adopted for each container, the shape of each container is not necessarily limited to such a shape.

That is, as a peripheral shape, a polygonal shape other than a rectangular shape or a circular shape or elliptical shape, etc., may be adopted, and moreover, for the bottom portion, a curved shape may be adopted instead.

Although in FIGS. 1(a), (b), and (c), frame-shaped ribs 6 are attached to reinforce an outer wall portion of each container, deformation of the container due to swelling can be prevented by such attachments.

FIG. 2 shows embodiments, each characterized in that between the plant growing container 2 at the uppermost side and the water purifying container 3 at the lowermost side, one or a mutually directly coupled plurality of the water purifying containers 3 of the basic configuration (1) or (2) is or are interposed, (a) shows a case where one water purifying container 3 is interposed, and (b) shows a case where a plurality (two) of the water purifying containers 3 are interposed.

With each of the above embodiments, purification of a large amount of water in an aquarium tank can be achieved as a whole upon setting an appropriate water circulation velocity in each individual water purifying container 3.

Moreover, a water circulation direction inside the aquarium tank can be dispersed by the one or plurality of water purifying containers 3 being interposed at an intermediate position between the uppermost side and the lowermost side, and, as in the embodiments shown in FIG. 1, an ill effect of causing a growth direction of aquatic plants 7 to be a specific direction due to specifying of the water circulation direction can be avoided.

FIG. 3 shows embodiments, each characterized in that between the plant growing container 2 at the uppermost side and the water purifying container 3 at the lowermost side, one or a mutually coupled plurality of the plant growing containers 2 of the basic configuration (1) or (2) is or are interposed through columnar bodies 21, each having a length not less than a height based on growth of the aquatic plants 7, (a) shows a case where one plant growing container 2 is interposed at the intermediate position between the uppermost side and the lowermost side, and (b) shows a case where a plurality (two) of the plant growing containers 2 are interposed.

With each of the embodiments shown in FIG. 3, growth of various aquatic plants 7 can be admired in accordance with setting of the plurality of plant growing containers 2.

Moreover, by the water circulation at the upper side of the aquarium tank which is formed by the water purifying container 3 at the lowermost side, in accordance with dispersing passage through the plurality of plant growing containers 2 in the vertical direction, specifying of the water circulation direction in the plant growing containers 2 is relaxed, that achieves the same effects as the embodiments shown in FIG. 2.

FIG. 4 shows embodiments, each characterized in that between the plant growing container 2 at the uppermost side and the water purifying container 3 at the lowermost side, the water purifying container 3 of the basic configuration (1) or (2) is directly coupled, and one or a mutually coupled plurality of the plant growing containers 2 of the basic configuration (1) or (2) is or are interposed through the columnar bodies 21 each having a length not less than a height based on growth of the aquatic plants 7, (a) shows a state where a plant growing container 2 is interposed at an upper side of the intermediate position other than the uppermost side and the lowermost side and the water purifying container 3 is interposed at a lower side of the intermediate position, and (b) shows a state where the water purifying container 3 is interposed at the upper side of the intermediate position other than the uppermost side and the lowermost side, a plant growing container 2 is interposed at the lower side of the intermediate position, and a plant growing container 2 is interposed further below.

The embodiments shown in FIG. 4 combine the embodiments of FIG. 2 and the embodiments of FIG. 3 and, by the combination, can achieve the effects of both the embodiments of FIG. 2 and the embodiments of FIG. 3.

Each of the pump communicating with the water drain pipe 31 in the basic configuration (1) and the water suction pipe 32 in the basic configuration (2) may be set either at an inner side or an outer side of a water purifying container 3, and FIG. 1 shows cases of setting at the outer side and FIGS. 2, 3, and 4 show cases of setting at the inner side.

Although a state where each water suction pipe 32 is installed in a water suction hole 34 that is not communicating with the pump and a state where each water drain pipe 31 is installed in a water drain hole 34 that is not communicating with the pump are shown in each figure, this does not necessarily mean that these pipes are indispensable.

A description shall now be provided in accordance with examples.

### Example 1

Example 1 is characterized in that sintered soil containing a fertilizer that contributes to plant growth is adopted as the sintered soil in the plant growing container 2, and sintered soil not containing the fertilizer is adopted as the sintered soil of the water purifying container 3.

Due to such a characteristic, sintered soil particles adapted respectively to growing the aquatic plants 7 and purifying water can be adopted in Example 1.

### Example 2

As shown in FIG. 3(a), Example 2 is characterized in that while a mesh 8 preventing entry of aquarium fish is disposed at upper sides of the plant growing containers 2, and meanwhile the water drain hole 34 and/or the water suction hole 34 of the water purifying container 3 are or is of a size allowing entry of aquarium fish.

Due to the above characteristic, aquarium fish are prevented from entering into the plant growing containers 2 and mainly enter inside the water purifying container 3 and thereby, accumulation of fish feces inside the plant growing containers 2 can be prevented.

In particular, if a transparent material is adopted as the side portion of the water purifying container 3, food for aquarium fish is disposed in the container, and a fish feces filtering filter is installed in the water drain pipe 31 according to the basic configuration (1) and the water drain hole 34 according to the basic configuration (2), then while aquarium fish swim and defecate inside the water purifying container 3, circulation and swimming of feces of the aquarium fish inside the aquarium tank can be prevented by intervention by the filter.

### Example 3

Example 3 is characterized in that a luminescent fine powder, capable of aggregating as colloid particles together with fish feces, dust, and dirt in water, is mixed in the water purifying container 3.

That is, whereas illumination by a light source is indispensable for the growth of the aquatic plants 7, if a luminescent fine powder such that aggregates integrally with fish feces, dust, and dirt, through a colloidal phenomenon is dispersed as in Example 3, the luminescent fine powder swims inside the aquarium tank, exhibits luster, and can enhance an ornamental effect by contrarily using the circulation of dust and dirt.

### INDUSTRIAL APPLICABILITY

As described above, the present invention, through the various embodiments, exhibits actions and effects not seen in conventional aquatic plant growing equipment and undoubtedly presents a groundbreaking applicability for such growing equipment.

### REFERENCE SIGNS LIST

1: Bed soil formed by layering of sintered soil particles
2: Plant growing container
21: Columnar body
23: Bottom portion of plant growing container
3: Water purifying container
31: Water drain pipe
32: Water suction pipe
33: Bottom portion of water purifying container
34: Water drain hole and water suction hole
5: Pump
6: Rib
7: Aquatic plants
8: Mesh preventing entry of aquarium fish

What is claimed is:

1. An aquatic plant growing equipment to be installed inside an aquarium tank, comprising:
a plant growing container disposed at an uppermost side of the equipment and which includes a bottom portion graveling sintered soil particles, allowing permeation of water and having a porous bed soil, and a side portion surrounding the bottom portion,
a water purifying container disposed at a lowermost side of the equipment and which includes a bottom portion graveling sintered soil particles having a porous bed soil, and a side portion surrounding the bottom portion, and
a water drain pipe communicating with a pump penetrating through the side portion of the water purifying container,
a water suction hole provided in the side portion of the water purifying container, and
the plant growing container disposed at the uppermost side and the water purifying container disposed at the lowermost side are coupled one of:
directly to each other in a vertical direction, or
indirectly in the vertical direction through one of:
at least one water purifying container,
at least one plant growing container, or
at least one water purifying container and at least one plant growing container.

2. An aquatic plant growing equipment to be installed inside an aquarium tank, comprising:
a plant growing container disposed at an uppermost side of the equipment and which includes a bottom portion graveling sintered soil particles, allowing permeation of water and having a porous bed soil, and a side portion surrounding the bottom portion,
a water purifying container disposed at a lowermost side of the equipment and which includes a bottom portion graveling sintered soil particles having a porous bed soil, and a side portion surrounding the bottom portion, and
a water suction pipe communicating with a pump penetrating through the side portion of the water purifying container,
a water drain hole provided in the side portion of the water purifying container, and
the plant growing container disposed at the uppermost side and the water purifying container disposed at the lowermost side are coupled one of:
directly to each other in a vertical direction, or
indirectly in the vertical direction through one of:
at least one additional water purifying container,
at least one additional plant growing container, or
at least one additional water purifying container and at least one additional plant growing container.

3. The aquatic plant growing equipment according to claim 1, wherein at least one additional said water purifying container is interposed between and mutually directly coupled between the plant growing container at the uppermost side and the water purifying container at the lowermost side.

4. The aquatic plant growing equipment according to claim 1, wherein at least one additional said plant growing container is interposed between and mutually directly coupled between the plant growing container at the uppermost side and the water purifying container at the lowermost side, through a columnar body having a length not less than a height based on growth of an aquatic plant therein.

5. The aquatic plant growing equipment according to claim 1, wherein between the plant growing container at the uppermost side and the water purifying container at the lowermost side, there are interposed and mutually coupled at least one additional said water purifying container and at least one additional said plant growing container through a columnar body having a length not less than a height based on growth of an aquatic plant therein.

6. The aquatic plant growing equipment according to claim 1, wherein the bottom portion of the plant growing container one of:
adopts a mesh having openings smaller than a particle diameter of the sintered soil particles, or
adopts a plate body, in which holes, smaller than the particle diameter, are arrayed in a regular manner.

7. The aquatic plant growing equipment according to claim 1, wherein sintered soil containing a fertilizer that contributes to plant growth is adopted as the sintered soil in the plant growing container, and sintered soil not containing the fertilizer is adopted as the sintered soil of the water purifying container.

8. The aquatic plant growing equipment according to claim 1,
wherein a mesh preventing entry of aquarium fish is disposed at an upper side of the plant growing container, and
wherein at least one of the water drain hole and the water suction hole of the water purifying container are of a size allowing entry of aquarium fish.

9. A method for using the aquatic plant growing equipment according to claim 8, comprising the steps of:
adopting a transparent material as the side portion of the water purifying container,
disposing food for aquarium fish in the water purifying container, and
installing a fish feces filtering filter in the water drain pipe.

10. A method for using the aquatic plant growing equipment according to claim 1, further comprising the step of mixing a luminescent fine powder, capable of aggregating as colloid particles together with fish feces, dust, and dirt in water, in the water purifying container.

11. The aquatic plant growing equipment according to claim 2, wherein at least one additional said water purifying container is interposed between and mutually directly coupled between the plant growing container at the uppermost side and the water purifying container at the lowermost side.

12. The aquatic plant growing equipment according to claim 2, wherein at least one additional said plant growing container is interposed between and mutually directly coupled between the plant growing container at the uppermost side and the water purifying container at the lowermost side, through a columnar body having a length not less than a height based on growth of an aquatic plant therein.

13. The aquatic plant growing equipment according to claim 2, wherein between the plant growing container at the uppermost side and the water purifying container at the lowermost side, there are interposed and mutually coupled at least one additional said water purifying container and at least one additional said plant growing container through a columnar body having a length not less than a height based on growth of an aquatic plant therein.

14. The aquatic plant growing equipment according to claim 2, wherein the bottom portion of the plant growing container one of:
adopts a mesh having openings smaller than a particle diameter of the sintered soil particles, or
adopts a plate body, in which holes, smaller than the particle diameter, are arrayed in a regular manner.

15. The aquatic plant growing equipment according to claim 2, wherein sintered soil containing a fertilizer that contributes to plant growth is adopted as the sintered soil in the plant growing container, and sintered soil not containing the fertilizer is adopted as the sintered soil of the water purifying container.

16. The aquatic plant growing equipment according to claim 2,
wherein a mesh preventing entry of aquarium fish is disposed at an upper side of the plant growing container, and
wherein at least one of the water drain hole and the water suction hole of the water purifying container are of a size allowing entry of aquarium fish.

17. A method for using the aquatic plant growing equipment according to claim 16, comprising the steps of:
adopting a transparent material as the side portion of the water purifying container,
disposing food for aquarium fish in the water purifying container, and
installing a fish feces filtering filter in the water drain hole.

18. A method for using the aquatic plant growing equipment according to claim 2, further comprising the step of mixing a luminescent fine powder, capable of aggregating as colloid particles together with fish feces, dust, and dirt in water, in the water purifying container.
